(19) United States
(12) Patent Application Publication
(10) Pub. No.: US 2004/0058182 A1
(43) Pub. Date: Mar. 25, 2004

(54) Glass preform with living hinge

(76) Inventor: Michael A. Strait, Johnstown, OH (US)

Correspondence Address: OWENS CORNING, 2790 COLUMBUS ROAD, GRANVILLE, OH, 43023, US

(21) Appl. No.: 10/247,571

(22) Filed: Sep. 19, 2002

(51) Int. Cl. B27N 3/10; B29C 43/18

(52) U.S. Cl. 428/542.8; 264/517; 264/309; 264/257; 264/255

(57) ABSTRACT

A glass preform having a living hinge section that is formed by introducing a continuous strand of fibrous material onto a portion of a screen and overspraying the strand and the rest of the screen with a chopped string binder material, therein forming a matted structure. The matted structure is subsequently heated to fuse together the binder material of adjacent chopped string binders to form the preform having a living hinge section. The preform may then be molded to form a three dimensional composite part such as a truck box. The living hinge section of the preform improves the flexibility of the preform during the molding process, thereby allowing for the preparation of complex three dimensional shapes.

### TECHNICAL FIELD

The present invention relates to glass preforms used in composite applications and more specifically to a glass preform having a living hinge for use in composite applications.

### BACKGROUND OF THE INVENTION

In the manufacture of pickup trucks, truck boxes are typically secured to the frame of the pickup truck directly behind the cab region. Because these truck boxes are required to hold and support heavy tools or the like, the strength of the truck box and the dividers is of great concern. Further, because these truck boxes are placed in open air environments in the truck beds, corrosion resistance is another important consideration. Further, it is also highly desirable to use lightweight materials to improve fuel economy and emissions. Because of these concerns, molded plastic materials are commonly used to form the truck boxes.

It is a primary drawback of the present state of the art with respect to containers in general, and truck boxes in particular, that the containers themselves are somewhat complex in nature. Because of this, the molds and tools used to form the containers are quite complex in nature and in most instances require multi-plane flow and forming of the polymer being molded. For this reason, the plastic materials that can be used in the molding process must be somewhat flexible in nature or must be able to flow to fill complex molds. Most plastic materials used in today's industry do not contain the strength necessary for truck box applications unless reinforced with a straight enhancing material such as glass or carbon fiber and the like.

To increase the strength of moldable plastic materials, it is common practice to introduce glass or other reinforcement materials to the plastic either prior to or during the molding process. One process that is used is a structural reaction injection molding (SRIM) process. In this process, a two component matrix polymer resin is injected into a mold containing a matrix of reinforcing fibers. The mold is maintained at an elevated temperature to activate and react together the two component matrix polymer resin. The mold is also subjected to higher pressure to ensure total wetout of the fibrous matrix. The mold is shaped to the proper dimension and configuration required for the finished composite part. One common two component matrix system consists of polyol and polyisocyanate reacting to form a finished polyurethane composite part. The SRIM process has many drawbacks, however. For example, it is difficult and expensive to form complex shapes. Further, equal dispersion of the fibrous reinforcing material throughout the part is essential or structural weakness in portions where fiber content is limited may be experienced. Also, it is difficult to achieve class A surface parts with the SRIM process.

One difficulty with these systems is that the fiber reinforcing member must first be formed substantially into the shape of the truck box prior to injection of the resinous component to form the preform. This shaped glass element is commonly known as a preform. To form the preform, a vacuum is directed to different portions of a preform screen containing the fiberglass material to compress and hold the fiberglass on the screen surface, a process that requires a large vacuum pressure over a large area. Compaction screens are then required to keep the fiberglass in place on the screen surface.

Another problem is that the method of forming the preform must be capable of applying the fiber coating equally over a three dimensional area. Typically, a 6-axis robot is required to accomplish this task, a process that is both time consuming and expensive. Also, a vacuum must be maintained on the glass preform and compaction screen to maintain the preform on the compaction screen until the resinous component of the preform hardens (or cures) to form the preform.

It is thus highly desirable to form fiber reinforced polymer materials in a simple, cost effective manner that does not require complex spraying equipment and large vacuums. It is also desirable that the materials formed may be subsequently shaped to form relatively complex three dimensional parts such as truck beds and bedliners.

### SUMMARY OF THE INVENTION

The present invention enables the manufacture of a glass preform with a “living hinge section” for input to a truck box structural reinforced injection molding process.

The concept incorporates a continuous strand that is sprayed onto a preform at an area that will become a hinge line. The entire preform is then sprayed with a string binder. The preform is then introduced into a three-dimensional injection type mold and conformed to the desired part shape. The continuous strand is flexible and allows for easy shaping in the hinge area.

The foregoing and other advantages of the invention will become apparent from the following disclosure in which one or more preferred embodiments of the invention are described in detail and illustrated in the accompanying drawings. It is contemplated that variations in procedures, structural features and arrangement of parts may appear to a person skilled in the art without departing from the scope of or sacrificing any of the advantages of the invention.

### BRIEF DESCRIPTION OF DRAWINGS

FIG. 1 is a perspective view of a truck constructed in accordance with one embodiment of the present invention;

FIG. 2 is a side view of a screen corresponding to the truckgate as shown in FIG. 1;

FIG. 3 is a top view of FIG. 2;

FIGS. 4 and 5 are a illustrate the process for forming a glass fiber matted structure onto the screen of FIG. 3;

FIG. 6 is a logic flow diagram for making a preform from the glass fiber matted structure of FIG. 5;

FIG. 7 is a perspective view of the preform formed in FIG. 6; and

FIG. 8 is a logic flow diagram for forming a composite bedliner from the preform of FIG. 7.

### DETAILED DESCRIPTION AND PREFERRED EMBODIMENTS OF THE INVENTION

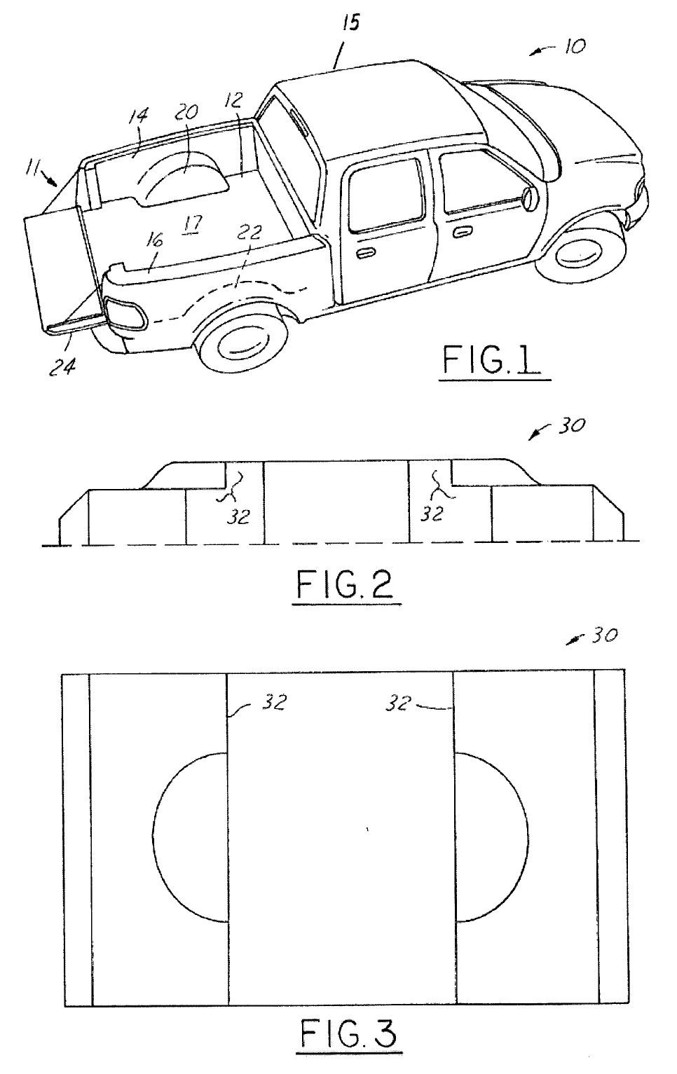

FIG. 1 illustrates a pickup truck 10 having a truckgate 11 and a cab section 15. The truckgate 11 typically has an open truck box 12 and a tailgate 24. The truck box 12 is typically secured to the vehicle frame and cab section 15 by methods well known in the art. The truck box 12 has a pair of sidewalls 14, 16 and a bottom wall 17. A pair of wheel wells 20, 22 are also typically contained within the truck box 12. The truck box 12 of the present invention is comprised of a fiber reinforced thermoplastic material that is made from a novel fiberglass preform 50. The method for forming the fiberglass preform 50 is shown below in FIGS. 2-6.

FIGS. 2 and 3 illustrate a cross-sectional and top view of a glass preform screen 30 that is used to make a matted structure 70 that is subsequently processed to form a preform 50 according to one preferred embodiment of the present invention. The preform screen 30 is semi-flat in profile and is sized to substantially match the dimensions of the truck box 12. As best shown in FIG. 2, a portion 32 of the screen 30 corresponding to the junction between each of the sidewalls 14, 16 and bottom wall 17 is formed in a hinge out pattern that will subsequently form a living hinge section 77 on the preform 50 as described below.

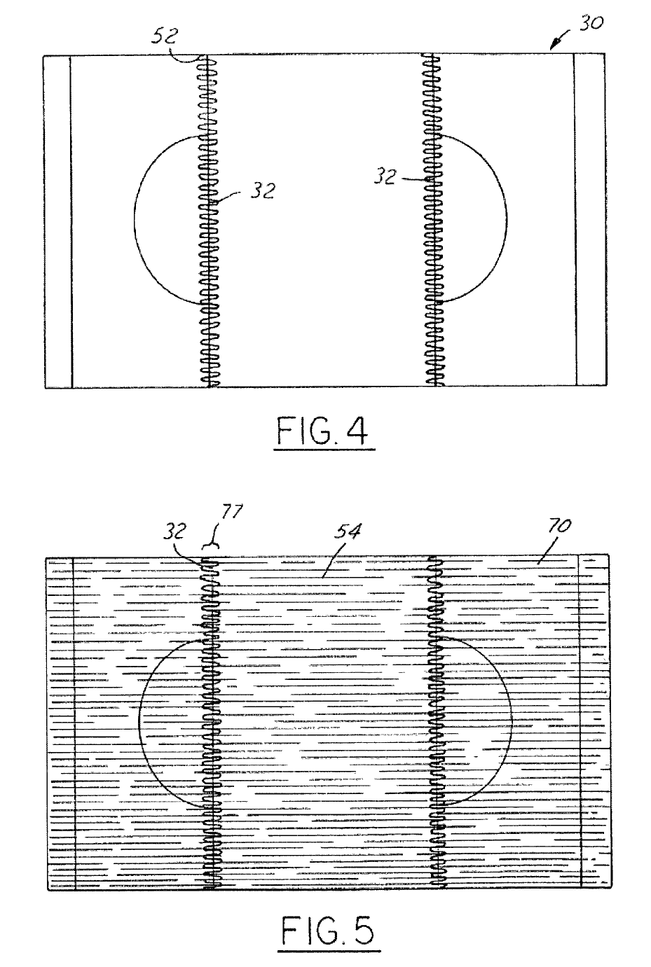

FIGS. 4 and 5 illustrates the method for making a fiberglass matting structure 70 using the preform screen 30 according to one preferred embodiment of the present invention. As shown in FIG. 4, a continuous strand 52 of fibrous material is sprayed along the portion 32 of a metal screen 30 within a chamber 60 featuring a down draft of air, preferably at about 150 cfm, through the screen 30.

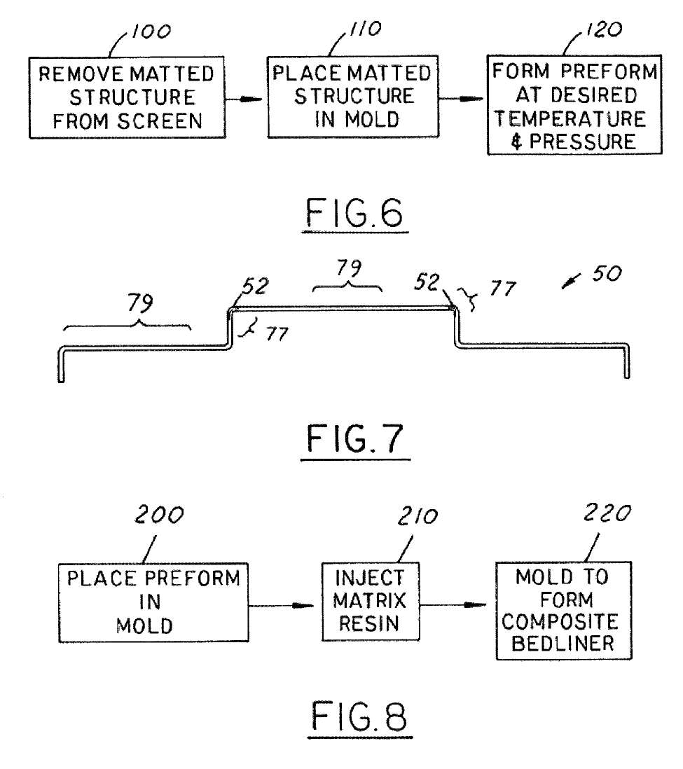

Next, as shown in FIG. 5, a string binder 54 is applied in chopped segments of about 3 inches in length over the entire surface of the preform screen 30 using a spray up process. In a preferred embodiment, the segments of string binder 54 are blown or spread by conventional means over the semi-flat preform screen 30 by supplying a down draft of air, preferably at about 150 cfm, through the screen 30 to form a predetermined vacuum pressure. Also, a sufficient level of heat is applied to the segments of string binder 54 as they are sprayed so as to soften the binder resin enough to permit fusing of some segments. Preferably, suction is applied to promote compacting of the segments as they fuse. The process of fusing allows the layered material to conform to the shape of the screen 30, and the material is then set in a solid matted structure 70 that can be physically transported if necessary. The matting structure 70 may be subsequently processed to form a preform 50 having a living hinge section 77 as shown below in FIG. 6.

The continuous strand 52 of fibrous material is preferably in the form of a continuous strand composed of multiple filaments. The strands may take the form of yarns, or rovings, including two-end and four-end rovings. Typically, such reinforcing strands are formed by combining filaments of the reinforcing fiber material as they are attenuated from a fiber-forming apparatus such as a bushing or orifice plate, although they may also be made by any method conventionally known in the art. The filaments may be coated with a sizing composition comprising functional agents such as lubricants, coupling agents and film-forming polymers, after which they are gathered into strands. These strands may then be formed into yarns or rovings.

One preferred continuous strand 52 is a glass-roving product such as K75 S-O forming cake fibrous glass (7500 yds./lb.). Another preferred strand is a yarn product such as G-75 glass yarn (7500 yds./lb.). Both of these products are commercially available from Owens Corning. Alternatively, the continuous strand 52 may be in the form of a string binder, in which strand has a thermoformable binder resin deposited thereon prior to application to the screen 30.

The string binder 54 comprises a fibrous carrier material with a thermoformable binder material to form a solid product that may be used in continuous or chopped form as a raw material in the preparation of preforms for molding process. In such an embodiment, the binder material is solidified on at least a portion of the fibrous carrier material. A catalyst that effects the cure of the binder resin during the manufacture of a reinforcing article is also present and is either directly incorporated into the thermoformable binder resin or incorporated into a separately applied layer to the fibrous carrier material. As used herein, the term “thermoformable” is intended to mean a resin that can be formed by heating, such as a thermoplastic, or a resin that is irreversibly set using heat, such as a thermosetting resin. The term “fibrous carrier material” is defined to mean a fibrous substrate selected from materials that are commonly used in the art. The “binder resin material” is a polymer that is used to fuse the fibers or strands of the fibrous carrier material such that the mixture of fibrous carrier material and the binder resin material may be solidified and cured to form a reinforcing article such as a preform, which may be used in a further manufacturing process to form a composite article. The ratio of the amount of fibrous carrier material to the amount of binder resin material is preferably about 50:50 in the string binder 54.

One preferred string binder 54 that is commercially available and may be used is ME 2000, available from Owens Corning. This string binder 54 is fused to form the preform 50 in the downward forced air oven at approximately 230 to 235 degrees Celsius (about 450 degrees Fahrenheit) for about 5 minutes.

Another preferred string binder 54 is disclosed in U.S. patent application Ser. No. 09/280,808 entitled “String Binders”, which is herein incorporated by reference. In this application, the binder resin material is a crystalline resin that has been modified to have an acid value of less than about 30 mg KOH/g resin, and more preferably less than about 10 mg KOH/g resin. The preferred binder resins that may be used in the practice of this invention include one or acid-modified thermoplastic or thermosetting resins, such as a crystalline polyester resin. Preferably, the low-acid crystalline polymers are manufactured by controlling the proportions of ingredients and processing conditions during polymerization. The resulting modified resin comprises particularly desirable molar properties of the monomers that are condensed to form the polymer. Exemplary combinations of polymers that may be formed by a combination of different monomers is set forth below:

| Monomers | Molar Ratios |
|---|---|
| ethylene glycol/fumaric acid | 1.0/1.0 |
| 1,6-hexanediol/fumaric acid | 1.02/1.0 |
| 1,6-hexanediol/ethylene glycol/fumaric acid | 0.82/0.2/1.0 |
| 1,6-hexanediol/ethylene glycol/fumaric acid | 0.92/0.1/1.0 |
| 1,6-hexanediol/1,4-butanediol/fumaric acid | 0.82/0.2/1.0 |
| 1,6-hexanediol/1,4-butanediol/fumaric acid | 0.92/0.1/1.0 |
| 1,6-hexanediol/1,4-cyclohexanedimethanol/ | 0.92/0.1/1.0 |
| fumaric acid | |
| 1,6-hexanediol/1,4-cyclohexanedimethanol/ | 0.82/0.2/1.0 |
| fumaric acid | |
| 1,4-butanediol/fumaric acid | 1.03/1.0 |
| 1,4-butanediol/ethylene glycol/fumaric acid | 0.82/0.2/1.0 |
| 1,4-butanediol/ethylene glycol/fumaric acid | 0.70/0.3/1.0 |
| 1,4-butanediol/ethylene glycol/fumaric acid | 0.92/0.1/1.0 |
| 1,4-butanediol/1,6-hexanediol/fumaric acid | 0.82/0.2/1.0 |
| 1,4-butanediol/1,6-hexanediol/fumaric acid | 0.92/0.1/1.0 |
| 1,4-cyclohexanedimethanol/ethylene | 0.93/0.1/1.0 |
| glycol/fumaric acid | |
| 1,4-cyclohexanedimethanol/ethylene | 0.83/0.2/1.0 |
| glycol/fumaric acid | |
| 1,4-cyclohexanedimethanol/1,6-hexanediol/ | 0.83/0.2/1.0 |
| fumaric acid | |
| 1,4-cyclohexanedimethanol/1,6-hexanediol/ | 0.90/0.1/1.0 |
| fumaric acid | |
| 1,4-cyclohexanedimethanol/1,4-butanediol/ | 0.83/0.2/1.0 |
| fumaric acid | |
| 1,4-cyclohexanedimethanol/1,4-butanediol/ | 0.90/0.1/1.0 |
| fumaric acid | |

Referring now to FIG. 6, a logic flow diagram for forming a preform 50 from the matted structure 70 is illustrated. First, in Step 100, the matted structure 70 is removed from the screen 30. Next, in Step 110, the matted structure 70 is placed into a downward forced air oven set a predetermined temperature and time to further soften the binder resin on the string binder 54 to fuse together adjacent string binder 54 segments and fuse the string binder segments to the strand 52, thereby forming the preform 50. The time and temperature necessary to form the preform 50 are dependent upon many factors, including the thickness of the preform 50, the composition of the binder component of the string binder 54, and to a lesser extent the type of fibrous reinforcement used. For most preferable systems, a temperature of approximately 225 to 250 degrees Celsius for about 4-6 minutes is sufficient to ensure fusing of the string binder 54 to both the strands 52 and other segments of the string binder 54 to form the preform 50.

As shown in FIG. 7, the preform 50 formed according to the logic as shown in FIG. 6 is preferably maintained in the shape of the screen 30. The preform 50 has a living hinge section 77 and a fused fiber section 79 surrounding the living hinge section 77. The living hinge section 77 comprises the continuous strands 52 fused to a portion of the plurality of fused chopped segments of string binder 54 while the fused fiber section 79 is comprised entirely of fused segments of string binder 54. The presence of the continuous strand 52 in the region of the living hinge section 77 provides the living hinge section 77 with increased flexibility and can be easily manipulated into complex shapes.

As shown in FIG. 8, the resulting preform 50 may then be subsequently processed to form a composite article, here truck box 12, using an otherwise conventional molding process, for example liquid resin molding or injection molding process. In Step 200, the preform 50 is placed in a mold cavity of a mold, preferably an injection mold. In Step 210, a matrix resin is injected into the mold in a method well known to those of skill in the art. Any moldable materials which are compatible with the thermoset binder material of the preform 50 can be used as the matrix resin 78 system of the composites. Typical matrix resins 78 that can be used include vinyl esters, polyesters, polyurethanes and phenolic thermoplastics.

Next, in Step 220, the preform 50 is molded at a desired pressure and temperature to form a composite article. In these molding techniques, the living hinge section 77 of the preform 50 provides the preform 50 with added flexibility in which to form more complex three-dimensional shapes such as those used in truck boxes 26.

The mold used in a preferred molding process as shown in FIG. 8 is a 4000-ton press fitted for structural reaction injection molding. The press is closed and the injection cycle injected with Baydur 425, a 2-part polyurethane available from Bayer, as the matrix resin 78. Molding is accomplished at 200° F. at 100 psi to form the composite truck box 26.

The technique for forming the preform 50 and truck box 12 used in the present invention offers many advantages over prior art processes. First, the semi-flat profile of the screen 30 allows for a reduction in vacuum pressure and airflow required to secure the glass in the form of strands 52 and string binder 54 to the screen 30 as compared with those required to form complex shapes. The semi-flat profile also allows for directed vacuum pressure to minimal areas of the preform screen 30. Also, the semi-flat profiles simplify the equipment used to spray the matted structure 70, in that the use of six-axis robotic sprayers for spraying a complex three-dimensional shape is eliminated. Further, the semi-flat profile allows for elimination of compaction screens that are commonly used to compress and hold the preform glass on the screen surface.

While the invention has been described in terms of preferred embodiments, it will be understood, of course, that the invention is not limited thereto since modifications may be made by those skilled in the art, particularly in light of the foregoing teachings.

What is claimed is:

1. A method for forming a glass preform having a living hinge section comprising:
providing a screen having a semi-flat profile;
introducing a continuous strand of fibrous material onto a portion of said screen, said portion corresponding to the living hinge section of the subsequently formed glass preform;
introducing a plurality of chopped string binder segments over said screen to form solid matted structure;
introducing said solid matted structure to a downward forced air oven for a predetermined period of time and a predetermined temperature sufficient to form the preform having the living hinge section.

2. The method of claim 1, wherein introducing a continuous strand of fibrous material comprises introducing a continuous strand of a multiple filament glass fiber product onto a portion of said screen, said portion corresponding to the living hinge section of the glass preform.

3. The method of claim 2, wherein introducing a continuous strand of a multiple filament glass fiber product comprises introducing a continuous strand of a glass roving product onto a portion of said screen, said portion corresponding to the living hinge section of the glass preform.

4. The method of claim 2, wherein introducing a continuous strand of a multiple filament glass fiber product comprises introducing a continuous strand of a glass yarn onto a portion of said screen, said portion corresponding to the living hinge section of the glass preform.

5. The method of claim 1, wherein introducing a continuous strand of fibrous material comprises introducing a continuous strand of string binder onto a portion of said screen, said portion corresponding to the living hinge section of the glass preform.

6. The method of claim 1, wherein introducing a continuous strand of fibrous comprises spraying a continuous strand of fibrous material onto a portion of said screen under vacuum pressure, said portion corresponding to the living hinge section of the glass preform.

7. The method of claim 1, wherein introducing a plurality of chopped string binder segments over said screen to form solid matted structure comprises spraying a plurality of chopped string binder segments over said screen under vacuum pressure.

8. The method of claim 1, wherein introducing a plurality of chopped string binder segments over said screen to form solid matted structure comprises:
introducing a plurality of chopped string binder segments to a sprayer;
heating each said plurality of chopped binder segments to a temperature sufficient to soften a binder resin on each of said plurality of chopped binder segments; and
spraying a plurality of chopped string binder segments onto said screen under vacuum pressure, wherein at least two of said plurality of binder segments fuse together and to said continuous strand of fibrous material to form a matted structure.

9. The method of claim 1, wherein introducing said solid matted structure comprises introducing said solid matted structure to a downward forced air oven for a between 4 and 6 minutes at between approximately 225 and 250 degrees Celsius to form the semi-flat preform having the living hinge section.

10. A preform for use in forming composite articles comprising:
a fused fiber section comprised of a plurality of chopped segments of said string binder, wherein one of said plurality of chopped segments is fused to an adjacent one of said plurality of chopped segments; and
a living hinge section adjacent to and fused within said fused fiber section, said living hinge section comprising a continuous strand of fibrous material coupled to at least one of said plurality of chopped segments.

11. The preform of claim 10, wherein said continuous strand of fibrous material comprises a continuous strand of a multiple filament glass fiber product.

12. The preform of claim 11, wherein said continuous strand of a multiple filament glass fiber product comprises a continuous strand of a multi-end glass roving.

13. The preform of claim 12, wherein said multi-end glass roving comprises a two-end glass roving.

14. The preform of claim 12, wherein said multi-end glass roving comprises a four-end glass roving

15. The preform of claim 11, wherein said continuous strand of a multiple filament glass fiber product comprises introducing a continuous strand of glass yarn.

16. The preform of claim 10, wherein said continuous strand of fibrous material comprises a continuous strand of string binder.

17. The preform of claim 16, wherein said continuous strand of string binder comprises a continuous strand of ME 2000 string binder, available from Owens Corning.

18. A method for forming a composite article comprising:
providing a screen having a semi-flat profile;
introducing a continuous strand of fibrous material onto a portion of said screen;
introducing a plurality of chopped string binder segments over said screen and said continuous strand to form solid matted structure;
introducing said solid matted structure to a downward forced air oven for a predetermined period of time at a predetermined temperature sufficient to form a preform having a living hinge section;
introducing said preform to a molding machine;
introducing a matrix material to said molding machine; and
molding said preform and said matrix material within said molding machine to form the composite part.

19. The method of claim 18, wherein introducing a continuous strand of fibrous material comprises introducing a continuous strand of string binder onto a portion of said screen.

20. The method of claim 18, wherein introducing said preform to a molding machine, introducing a matrix material, and molding said preform comprises:
introducing said preform to a 4000-ton press fitted for structural reaction injection molding;
closing said press;
injecting a polyurethane matrix material to said press;
molding said polyurethane matrix material and said preform at about 200 degrees Fahrenheit and 100 pounds per square inch to form a composite article.
